(19) United States
(12) Patent Application Publication
(10) Pub. No.: US 2016/0162591 A1
(43) Pub. Date: Jun. 9, 2016

(54) Web Content Tagging and Filtering

(71) Applicant: Microsoft Technology Licensing, LLC, Redmond, WA (US)

(72) Inventors: Akriti Dokania, Seattle, WA (US); Megan M. Quintero, Seattle, WA (US)

(21) Appl. No.: 14/561,109

(22) Filed: Dec. 4, 2014

(51) Int. Cl. G06F 17/30; G06F 3/0484; G06F 3/0482

(52) U.S. Cl. CPC G06F 17/30876; G06F 17/30598; G06F 3/0482; G06F 3/04842

(57) ABSTRACT

Techniques for tagging and filtering of web content accessed via a web platform are described herein. Content items added to quick links data are automatically tagged with contextual metadata tags indicative of filterable properties of browsing activity. A request is subsequently received to access the quick links data and the quick links data is filtered to generate an arrangement of quick links in groups of related items. The user interface is configured with visual representations for each of the groups to expose the arrangement of quick links and facilitate user interaction to access content items through the web platform using the groups. For example, a quick link access page may be output to show filtered views of browsing history, bookmarks, and/or favorites in relevant groupings based on tags associated with content items.

### BACKGROUND

Users of web browsers today often repeat work (e.g., searching for and browsing to websites) to continue recent or frequent browsing activities, such as shopping for a particular item or researching a particular topic. Conventionally, web browsers may provide histories of recently visited sites, favorites, and/or bookmarks to help user get back to previous work, which are referred to herein collectively as “quick links.” Today, quick links data is largely text and URL based, which requires users to remember textual names and strings to navigate back to particular content. Unfortunately, users often have difficulty recalling textual components, site names, and URL strings associated with browsing activities and may be better at remembering the context in which activities occur. Accordingly, traditional text based history and favorite data approaches may have limited effectiveness at assisting users in returning quickly to previous activities.

### SUMMARY

Techniques for tagging and filtering of web content are described herein. In one or more implementations, content items added to quick links data during a user's browsing activity via a web platform are automatically tagged with contextual metadata tags indicative of filterable properties of browsing activity. In one approach, data available via an existing search service and/or other services of the web platform may be leveraged to determine at least some of the contextual metadata tags that are appropriate for different content items. A request is subsequently received to access the quick links data via a user interface provided by the web platform. In response, the quick links data is filtered to generate an arrangement of quick links in groups of related items each corresponding to one or more of the contextual metadata tags. The user interface is configured with visual representations for each of the groups to expose the arrangement of quick links and facilitate user interaction to access content items through the web platform using the groups. For example, a quick link access page may be output to show filtered views of browsing history, bookmarks, and/or favorites in relevant groupings based on tags associated with content items.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the following discussion.

FIG. 1 is an illustration of an environment in an example implementation that is operable to support techniques described herein.

FIG. 2 illustrates an example scenario for web content tagging and filtering in accordance with one or more implementations.

FIG. 3 depicts an example procedure in which tags associated with content items are used to produce a visual representation of quick links.

FIG. 4 depicts an example user interface having a visual representation of quick links in accordance with one or more implementations.

FIG. 5 depicts an example procedure in which a rearrangement of a view of quick links occurs based on a filter selection.

FIG. 6 depicts an example user interface having a visual representation of quick links with a filter selector in accordance with one or more implementations.

FIG. 7 depicts a representation of rearrangement of quick links based on a filter selection in accordance with one or more implementations.

FIG. 8 depicts an example procedure in which a link to a filtered view of quick links is returned as part of search results.

FIG. 9 depicts an example user interface for accessing and searching quick links in accordance with one or more implementations.

FIG. 10 illustrates an example system having devices and components that may be employed to implement aspects of the techniques described herein.

### DETAILED DESCRIPTION

Overview

Users often have difficulty recalling textual components, site names, and URL strings associated with browsing activities and may be better at remembering the context in which activities occur. Accordingly, traditional text based history and favorite data approaches may have limited effectiveness at assisting users in returning quickly to previous activities.

Techniques for tagging and filtering of web content are described herein. In one or more implementations, content items added to quick links data during a user's browsing activity via a web platform are automatically tagged with contextual metadata tags indicative of filterable properties of browsing activity. A request is subsequently received to access the quick links data via a user interface provided by the web platform. In response, the quick links data is filtered to generate an arrangement of quick links in groups of related items each corresponding to one or more of the contextual metadata tags. The user interface is configured with visual representations for each of the groups to expose the arrangement of quick links and facilitate user interaction to access content items through the web platform using the groups. For example, a quick link access page may be output to show filtered views of browsing history, bookmarks, and/or favorites in relevant groupings based on tags associated with content items. Quick links associated with tags may also be returned as results of searches for search terms that match the tags wherever search functionality is provided by the web platform.

Techniques for tagging and filtering as described in this document enable a web platform to efficiently control arrangement of and access to browsing history and other quick links via different filtered views. The filtered views may include image-based representation of groups of links that can be identified visually as well as with corresponding tags. The image based groups and tags may be easier for users to remember than names of documents, URLs, or websites. Consequently, users are able to use the tags, groupings, and filtered views to more easily recall and access content items of interest. Image-based representations of groups also provide efficient use of limited screen real estate to surface relevant content items to a user and reduce the time and/or number of steps it takes for a user to locate content items of interest. Since tags may be automatically associated with content by the platform, users may also spend less time creating and organizing quick links and more time interacting with items of interest.

In the following discussion, an example environment is first described that may employ the techniques described herein. Example details and procedures are then described, which may be implemented in the example environment as well as other environments. Consequently, the example details and procedures are not limited to the example environment and the example environment is not limited to the example details and procedures. Lastly, an example system and components of the system are discussed that may be employed to implement aspects of the techniques described herein.

Example Environment

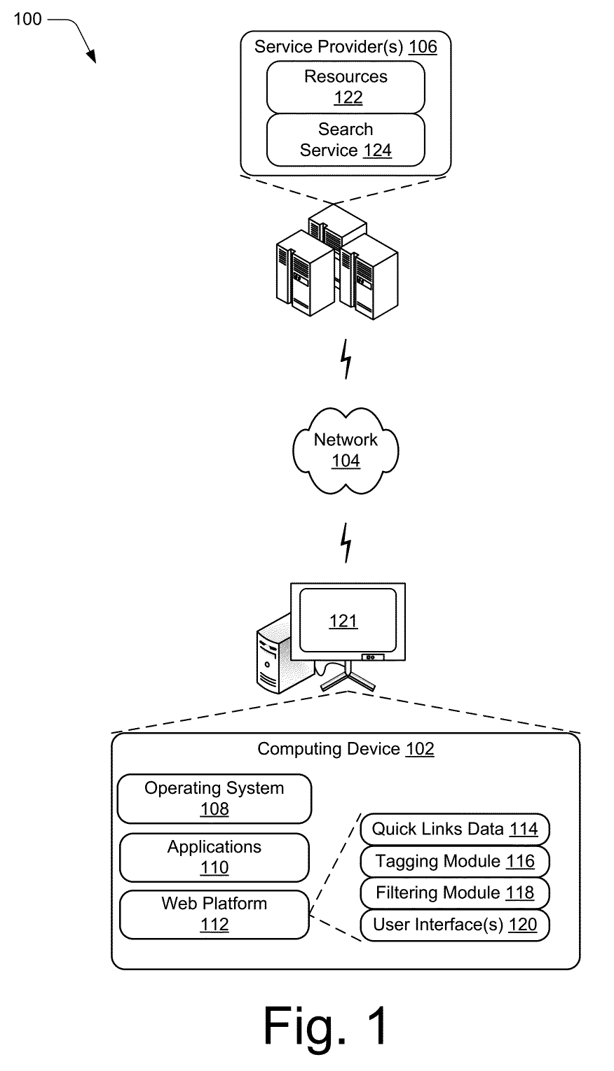

FIG. 1 is an illustration of an environment 100 in an example implementation that is operable to support techniques described herein. The illustrated environment 100 includes a computing device 102 that is communicatively coupled via a network 104 to a service provider 106. The computing device 102 and service provider 106 may be implemented by one or more computing devices and also may be representative of one or more entities.

The computing device 102 may be configured in a variety of ways. For example, a computing device may be configured as a computer that is capable of communicating over a network, such as a desktop computer, a mobile station, an entertainment appliance, a set-top box communicatively coupled to a display device, a wireless phone, a game console, educational interactive devices, point of sales devices, and so forth. Thus, the computing device 102 may range from full resource devices with substantial memory and processor resources (e.g., personal computers, game consoles) to a low-resource device with limited memory and/or processing resources (e.g., traditional set-top boxes, hand-held game consoles). Additionally, although a single computing device 102 is shown, the computing device 102 may be representative of a plurality of different devices, such as multiple servers utilized by a business to perform operations such as by a web service, a remote control and set-top box combination, an image capture device and a game console configured to capture gestures, to name a few examples.

The computing device 102 is further illustrated as including an operating system 108. The operating system 108 is configured to abstract underlying functionality of the computing device 102 to applications 110 that are executable on the computing device 102. For example, the operating system 108 may abstract the processing system 104, memory 106, and/or network functionality of the computing device 102 such that the applications 110 may be written without knowing “how” this underlying functionality is implemented. The applications 110, for instance, may provide data to the operating system 108 to be rendered and output for display via a graphics processing system without understanding how this rendering will be performed. The operating system 108 may also represent a variety of other functionality, such as to manage a file system and user interface that is navigable by a user of the computing device 102.

The computing device 102 also includes a web platform 112. The web platform 112 works in connection with content of the web, e.g. public content such as websites and the like. A web platform can include and make use of many different types of technologies such as, by way of example and not limitation, URLs, HTTP, REST, HTML, CSS, JavaScript, DOM, and the like. The web platform can also work with a variety of data formats such as XML, JSON, and the like. Web platforms can include web browsers, local applications such as a store or file management application, web-enabled desktop applications, and so forth. In the examples described below, a web platform in the form of a web browser that navigates to various websites is utilized. It is to be appreciated and understood, however, that the inventive principles can be employed by web platforms other than web browsers.

The computing device 102 may include quick links data 114 that stores web addresses (e.g., URLs), metadata, and other data corresponding to content items navigated to using the web platform 112. The quick links data 114 provides a record of a user's browsing activity using the web platform 112. The quick links data 114 may include items automatically added by the web platform 112 based on the user's browsing activity (e.g., browsing history) as well as items added as bookmarks or favorites by users. The quick data 114 be employed to generate and expose representations of content items having selectable, “quick” links to facilitate user navigation back to the items. By way of example, the representations of content items derived from quick links data 114 may include lists and/or image-based representations of browsing history, bookmarks, and favorites in different views, menus, and pages accessible via the web platform 112.

Accordingly, quick links data 114 includes indications regarding websites. web pages, documents, and other content that can be navigated to via a web platform using navigable addresses or identifiers. Examples of navigable addresses include uniform resource locators (URLs), uniform resource identifiers (URIs), internationalized resource identifiers (IRIs), and internationalized domain names (IDNs). Quick links data may also include user interactions with resources other than websites. For example, quick links data may include application usage data (e.g., a list of word processing applications, media player applications, or social media applications used by a user of computing device 102), document usage (e.g., word processing documents or spreadsheets created using applications), and media content usage (e.g., music files or video files played back at computing device 102). Thus, it is to be appreciated that quick links data 114 may store data associated with user interactions with a variety of different types of resources. Although illustrated as being stored at the computing device 102, quick links data 114 may also be stored remotely from computing device 102 (e.g., in the cloud). In one approach, quick links data 114 is communicated to the service provider 106 and stored in association with an account of a user for roaming of the quick links data 114 to different devices employed by the user.

Computing device 102 is further illustrated as including a tagging module 116 and a filtering module 118 that operate to implement techniques to tag and filter items stored as quick links data 114 as described above and below. In particular, the tagging module 116 is representative of functionality to associate various contextual metadata tags with content items that are added to quick links data 114. Contextual metadata tags may indicate filterable properties of browsing history that are defined for the web platform 112. Through the tagging module 116, the web platform automatically captures metadata related to content items and associates the metadata tags with quick links data 114. Metadata that is collected and associated with content items may include default or system level tags and values defined for the web platform, as well as user-defined, custom tags.

The filtering module 118 is representative of functionality to utilize the contextual metadata to define and apply filters to quick links data 114. The filters may be employed to produce and manipulate views of the quick links data 114 exposed via the web platform 112. For example, one or more filters may be used to organize browsing history items into an arrangement of corresponding groups when a user accesses and/or searches the browsing history. Rather than merely providing a list of history items (e.g., a textual list or hierarchal tree), the web platform 112 creates visual arrangements of browsing history (and other quick links data 114) using image-based representations. Additionally, the filtering module 118 may provide a filter selector to enable selection of different filters to apply to views of quick links data 114 to arrange and rearrange visual arrangements and groupings of quick links data. Filters may also be applied during searches of quick links data 114 and web content to provide filtered items as part of the search results.

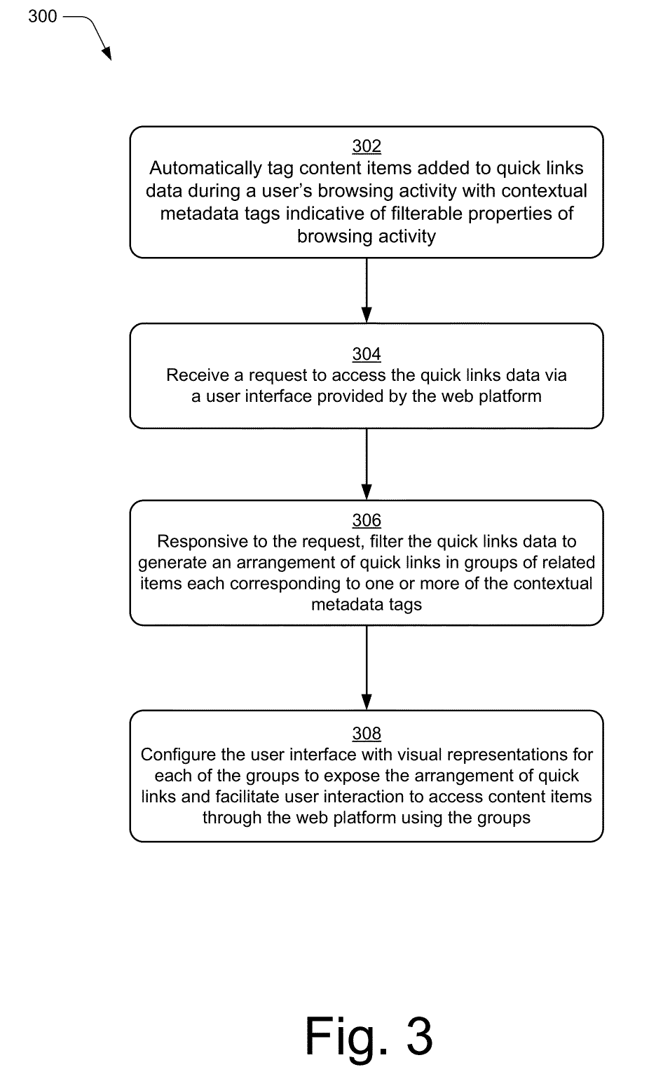

The web platform 112 is configured to cause output of user interfaces 120 on a display device 121 of the computing device 102, including pages configured to provide different views of quick links data 114. For instance, the web platform 112 may produce views for interaction with content accessed via the web platform and send commands and data to a graphics processing system of the computing device to control operation of the graphics processing system for rendering of user interfaces 120. The display device 121 may be an integrated or external display and may be configured in any suitable way to present the user interfaces 120. Some example procedures and user interfaces for web content filtering and tagging are discussed in relation to FIGS. 3 to 9 below.

The service provider 106 as depicted in FIG. 1 includes functionality operable to manage various resources 122 that may be made available over the network 108. For example, service provider 106 may provide various resources 122 via webpages or other user interfaces that are communicated over the network for output by one or more clients via a web browser or other client application. The service provider 106 is configured to manage access to the resources 122, performance of the resources, and configuration of user interfaces to provide the resources 122, and so on. The service provider 106 may represent one or more server devices used to provide the various resources 122.

Generally, resources 122 made accessible by a service provider 106 may include any suitable combination of services and/or content typically made available over a network by one or more providers. Some examples of services include, but are not limited to, a search service, an email service, an instant messaging service, an online productivity suite, and an authentication service to control access of clients to the resources 122. Content may include various combinations of text, multi-media streams, documents, application files, photos, audio/video files animations, images, web pages, web applications, device applications, content for display by a browser or other client application, and the like.

One particular example of a resource that may be accessible via the service provider is a search service 124 as represented in FIG. 1. The search service 1242 is representative of a service to perform various tasks to generate search results in response to search terms input via the web platform. Search results may be provided to client devices to facilitate navigation to access content via a network 104 through links included with the results. The search service 124 may also collect contextual metadata regarding content items that may be used to index content and generate results that match input search terms. In one or more implementations, the search service 124 may expose contextual metadata for use by the web platform 112. Among other things, the web platform 112 may be configured to leverage contextual metadata supplied via the search service to tag content items with appropriate tags, set-up filters for the tagged content, filter quick links, and generate image-based views of the quick links in the manner described herein.

Having considered the foregoing example environment, consider now a discussion of some further details of techniques for web content tagging and filtering in accordance with one or more implementations.

Web Content Tagging and Filtering Details

Example Scenario

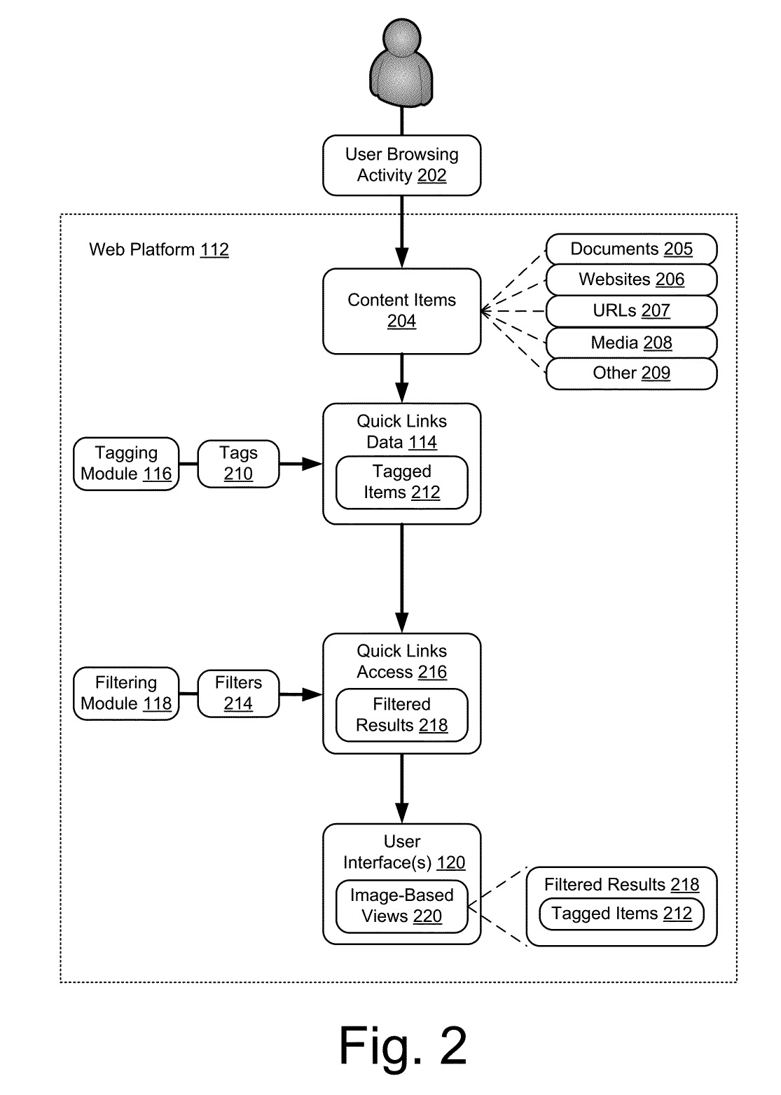

To further illustrate, FIG. 2 depicts generally at 200 an example scenario for web content tagging and filtering in accordance with one or more implementations. In this example, operations of a web platform 112 in connection with user browsing activity 202 is represented. User browsing activity 202 may involve navigation of a browser or other web-enabled application to access content items 204. The web platform 112 may enable interaction with various different types of content. By way of example, content items in FIG. 2 include documents 205 associated with applications, websites 206 and URLs 207 accessed via a service provider, media 208 items such as music files, video files, and digital images, and other 209 content that may be accessed, rendered and/or manipulated via the web platform 112.

The web platform 112 may generate and store quick links data 114 corresponding to content items 204 during user browsing activity 202. This includes automatically storing and updating a browsing history that keeps a record of content items accessed via the web platform. In addition or alternatively, the web platform 112 stores bookmarks and favorite list items in response to user input to add content items 204 as bookmarks or favorites. Quick links data 114 may be stored locally at a computing device, such as in a data file for a browser or other application. In addition or alternatively, quick links data 114 may be stored in association with a user's account with a service provider 106 for online access, synchronization between different devices, and roaming of the quick links data to different devices employed by a user.

Quick links data 114 may also be tagged with contextual metadata tags and filtered using techniques described above and below. To do so, the tagging module 116 operates to associate tags 210 with content items 204 and produce tagged items 212 as represented in FIG. 2. A variety of different tags 210 are contemplated that are associated with properties of content items 204 and the context in which the content items are accessed via the web platform 112. Broadly speaking, the tags 210 are configured to provide indications regarding when content was accessed (e.g., time, day, week, month), where content was accessed (e.g., home or work, geographic or other location information, computing device used), what was accessed (e.g., content type, page information, source, task/activity category such as travel, shopping, or reading), how access occurred (e.g., page referral data, link sharing indications regarding whether the content was shared to or by the user, access mechanisms through direct browsing, links, email, a browser or other web enabled application.), and who was involved (e.g., users who shared content, user to whom content was shared, friends and groups that accessed and/or rated the content, likes or dislikes). More particularly, tags may include corresponding field and value combinations for time/date, locations, device IDs, content categories, task categories, source IDs, page referrals, content sharing and rating data, application IDs, entities related to pages, frequency of access, and other contextual metadata related to content items. Users may also be able to enter custom tags the user selects to label and relate a collection of items using the custom tag. As but one example, a user planning a trip to Paris may create a custom tag for “Paris” and assign this tag to pages, documents, web sites and other content items the user access as part of the planning.

Filters 214 may be defined for the web platform 112 using combinations of the tags 210 that are associated with tagged items 212. By way of example and not limitation, filters 214 may include time/date filters for categories such as today, this week, this month, and so forth. Filters 214 may also include entity filters for different people, groups, devices, content sources. Another type of filters 214 that may be employed is activity filters that relate to tasks such as buying a car, a trip to Paris, or a research paper, to name a few examples. Additional filters 214 may be defined to filter based on location, sharing status, document types, application or application type, and so forth. The filtering module 118 operates to apply filters 214 to form groups of related items each corresponding to one or more of the contextual metadata tags. As shown in FIG. 2, filtering based on tags may occur in connection with requests for quick links access 216, such as interaction with a page, menu, or link to view, search, or otherwise manipulate quick links data 114. In one approach, contextual metadata supplied via the search service otherwise may be used to establish filters and assign relevancy score to the different filter grouping based on criteria such as access frequency, number of links in the groups, last access time, user preferences such as for location or device, tag created by a user or automatically, and so forth. Filters may be ranked one to another based upon the relevancy score and rankings may be used to select and/or prioritize which content and filters to include in search results and as content items within user interfaces.

Application of the filters 214 produces filtered results 218, which are used to generate and cause output of user interfaces 120 for the web platform. Arrangement of elements within a user interface 120 for quick links may be controlled by the web platform in dependence upon selected filters. A filter selector may be provided that enables a user to select and deselect filters to produce different views of the quick links data 114. In particular, selections of different combinations of one or more available filters cause arrangement and rearrangement of representations of quick links within a user interface 120 into groups and/or categories corresponding to selected filters.

In accordance with techniques described herein, a user interface 120 may be configured with visual representations for each of the groups to expose the arrangement of quick links. The visual representations facilitate user interaction to access content items through the web platform using the groups. As shown in FIG. 2, visual representations provide image-based views 220 of the quick links that users employs to quickly locate and interact with content. The image-based views 220 may provide visual representations of tagged items 212 that are included in filter results 218. Additionally, the image-based views may include tag labels that identify groups and elements that represent content items within the groups. Elements used to represent content items may include thumbnail images that provide a preview of the content. Elements may also include graphic representations (e.g., icons) and/or links arranged into visually identifiable groupings. Visual representations of groups as well as individual elements within the grouping may be selectable to facilitate navigation of the web platform to access and render corresponding content. Rather than merely providing a list, which requires users to remember textual names and strings to navigate back to particular content, the image-based views 220 enable users to scan a visual representation of content and quickly locate items of interests. Additionally, the tag labels provide recognizable and/or custom group names that help users identify the groups and make the task of getting back to previous work easier to accomplish. Details regarding these and other aspects of web content tagging and filtering can be found in relation to the following example procedures and user interfaces.

Example Procedures and User Interfaces

The following discussion describes techniques and user interfaces that may be implemented utilizing the previously described systems and devices. Generally, the following procedures represent example procedures to facilitate user access to prior browsing activity via a web platform using tagging and filtering as described in this document. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference may be made to the environment 100 of FIG. 1 and the scenario of FIG. 2. For instance, aspects of the procedures may be performed by a suitably configured computing device, such as a device that includes or otherwise makes use of a web platform 112. Aspects of the procedures may also be performed by one or more server devices, such as a servers associated with a service provider 106 configured to provide a search service 124.

Functionality, features, and concepts described in relation to the examples discussed in relation FIGS. 1 and 2 may be employed in the context of the procedures and user interfaces described herein. Further, functionality, features, and concepts described in relation to different procedures below may be interchanged among the different procedures and are not limited to implementation in the context of an individual procedure. Moreover, blocks associated with different representative procedures and corresponding figures herein may be applied together and/or combined in different ways. Thus, individual functionality, features, and concepts described in relation to different example environments, devices, components, user interfaces, and procedures herein may be used in any suitable combinations and are not limited to the particular combinations represented by the enumerated examples.

FIG. 3 depicts an example procedure 300 in which tags associated with content items are used to produce a visual representation of quick links. Content items added to quick links data during a user's browsing activity are automatically tagged with contextual metadata tags indicative of filterable properties of browsing activity (block 302). For example, a web platform 112 may collect and store various metadata with quick links data such as browsing history, favorite items, and bookmarks. The quick links data may reflect a history of content items encountered during the user's browsing activity that is recorded by the web platform. Various types of tags are contemplated as noted previously. In an example, contextual metadata tags defined for a web platform include tags for one or more of time and date, locations, device IDs, content categories, task categories, source IDs, page referrals, content sharing and rating data, or application IDs. Moreover, the contextual metadata tags include one or more custom tags defined by a user, such as for a task such as buying a house, finding a job, or vacation planning. Custom tags may be utilized to help a user recall the task using a user-defined term and get back to the task quicker. In one approach, a tag dialog may be presented when items are added to quick links data, when navigation away from a page occurs, or just before the web platform is such down. The tag dialog may show tags assigned to an item by the web platform and provide options to confirm or remove the tags as well as to select different tags and/or create a new custom tag.

Quick links data may be store locally at a device for use by a web platform implemented via that device. Quick links data may also be synchronized and roamed between devices. For example, the web platform may communicate quick links data with corresponding contextual metadata tags to a service provider 106 for storage in association with a user account. This enables access to the quick links data and corresponding contextual metadata tags via the service provider from multiple devices used to access the user account.

A request is received to access the quick links data via a user interface provided by the web platform (block 304). For example, the web platform 112 may provide pages and/or other user interface constructs (e.g., menus, toolbars, windows, selection controls) to facilitate access to and manipulation of quick links data. The request may be received in response to navigation input to launch a quick links access page via the web platform, such as by a user selecting a link or menu item to launch the page.

Responsive to the request, the quick links data is filtered to generate an arrangement of quick links in groups of related items each corresponding to one or more of the contextual metadata tags (block 306). Filtering may be performed via a filtering module 118 or other comparable component of the web platform. In one or more implementations, the filtering is performed by applying one or more pre-selected filters defined for the web platform. In this approach, the filtering may cause generation of a default or home view of quick links having a system defined arrangement of quick links in groups. Filtering also occurs in response to user selection of filters to produce a filtered view that is selected by the user and corresponds to one or more filters applied by the user. For example, the user interface may be configured to expose a filter selector operable to select filters to apply to the quick links data. Filter selection causes rearrangement of the arrangement of quick links in accordance with selected filters.

Based on the filtering, the user interface is configured with visual representations for each of the groups to expose the arrangement of quick links and facilitate user interaction to access content items through the web platform using the groups (block 308). In one or more implementations, the arrangement of quick links in groups is configured to provide an image-based view of one or more of the user's browsing activity, bookmarks, or favorites. These different kinds of quick links may be combined in the view and/or may be accessible via different individual views for user's browsing activity, bookmarks, and favorites. Preview images for one or more content items may be included in visual representations of the groups. Preview images may be configured as captured images captured during previous interaction with a corresponding content items. In addition or alternatively, icons or other graphical representations may be used for some items. Tag labels may also be incorporated in one or more implementations as noted previously.

Accordingly, a web platform may operate to tag content items with a set of pre-defined tags as well as with custom tags. The web platform also operates to apply filters based on the tags to generate different views of quick links for the content items and cause presentation of the views via a user interface. As noted, this includes controlling operation of a graphics processing system to output the user interface for display via a display device, such as by sending commands and data to cause rendering via the graphics processing system.

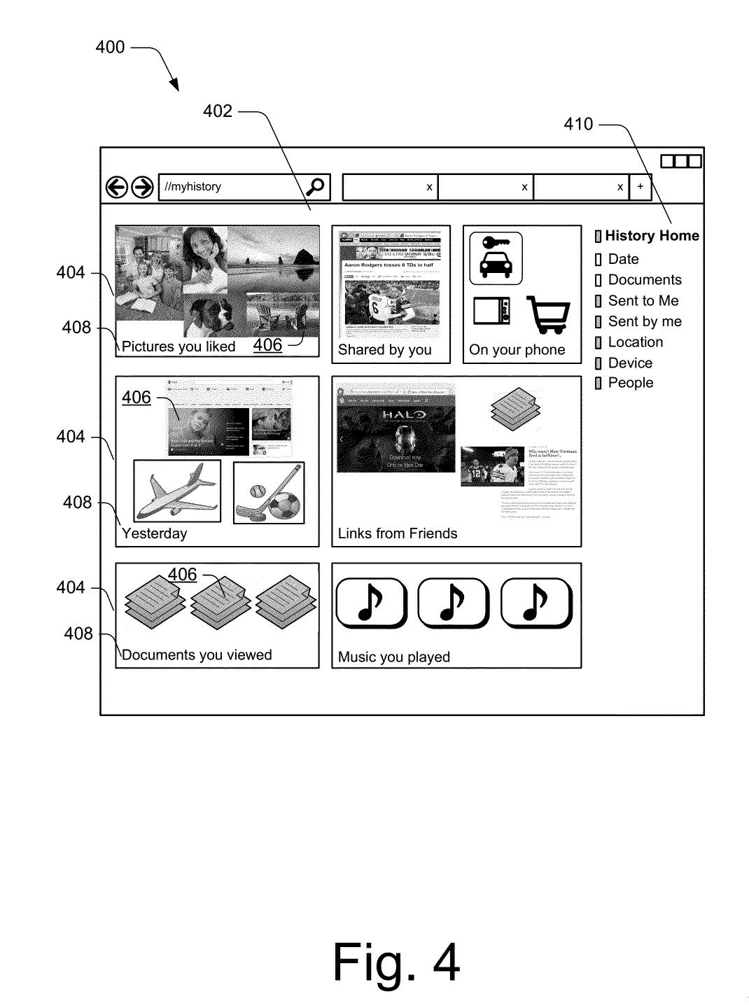

FIG. 4 depicts generally at 400 an example user interface having a visual representation of quick links in accordance with one or more implementations. In this example, a quick links access page 402 is shown that may be formed in accordance with procedure 300 of FIG. 3 and/or using other techniques described herein. The quick links access page 402 includes an arrangement of quick links in groups. Here the quick links access page 402 shows a history home view that shows a default view of browsing history. Comparable arrangements for favorites and bookmarks may be accessible via different pages, through filters and/or links include in the within the depicted view, and even in a combined manner within the depicted view.

The quick links access page 402 represents an image-based view as described herein. As such, the page includes visual group elements 404 for each of multiple different groups that contain corresponding quick link elements 406. The different groups also each include tag labels 408. Note that reference numbers are provided in the drawings for three representative groups on the left hand side of the drawing and omitted for the other groups for the sake of simplicity of the drawing.

In this example, the visual group elements 404 are rectangular boxes or tiles that act as containers for related items within groups derived from tags and filters. Other containers, layouts, and shapes are also contemplated. Example groups in FIG. 4 include pictures you liked, shared by you, on your phone, yesterday, links from friends, documents you viewed, and music you played. Each of these groups include items relevant to the group that are identified using the tags. For example, the pictures you liked group includes quick link elements 406 for different pictures. Similarly, the yesterday group include quick link elements 406 for content items accessed yesterday such as a news website page, a travel page, and a sports page.

Quick link elements 406 may include thumbnails or preview images, such as the news website page image in the yesterday group and the images in the pictures you liked group. Icons, tiles, or other image-based representations may also be employed for quick link elements 406, such as the icons for the travel page and sports page within the yesterday group. Document icons are also represented in the documents you viewed group.

In an implementation, at least some of the quick link elements 406 are configured as navigation links selectable to cause launch of corresponding items. In addition or alternatively, the visual group elements 404 may be selectable to drill down into an expanded view of the group and links within the group. In an implementation, quick links may be represented by static, non-operable images in the multiple group view depicted. Then, when a particular group is selected to drill down into that group, quick link elements 406 may be active as selectable elements in the expanded view that is exposed. Accordingly, visual group elements 404 and the quick link elements 406 may provide an efficient arrangement of quick links that facilitates user access to content items in various ways.

The quick links access page 402 also includes a filter selector 410 that enables selection of filters to arrange and rearrange quick links into different groups. Generally, the filter selector 410 provide multiple available filter options via selectable controls. In this example, the available filters include filters for history home (currently selected), date, document, sent to me, sent by me, location, device, and people. Selection of a filter other than the currently selected history home initiates a rearrangement of the groups to form new groupings corresponding to the selected filter. For example, selection of the date filter causes rearrangement of the quick links into groups formed for different dates (e.g., today, yesterday, this month, etc.). Likewise, selection of the location filter may cause rearrangement of the quick links into groups formed for different locations. The filter selector 410 may also provide functionality to create custom filters and views by selection of filters and/or grouping to include in a view. Thus, the filter selector 410 provides a convenient way for used to quickly create and/or access different views.

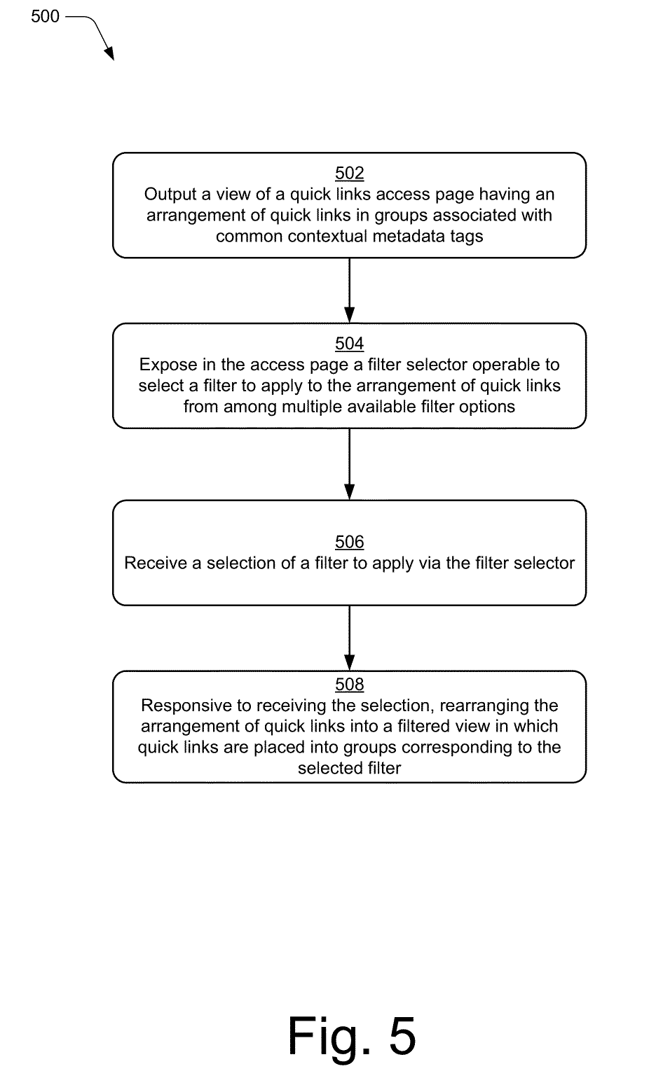

FIG. 5 depicts an example procedure 500 in which a rearrangement of a view of quick links occurs based on a filter selection. A view of a quick links access page is output having an arrangement of quick links in groups associated with common contextual metadata tags (block 502). For instance, the web platform 112 may cause display of a quick links access page as just described in relation to the procedure 300 of FIG. 3 and the example of FIG. 4. As noted previously, quick links may correspond to one or more of items added to a user's browsing history, bookmarks, or favorites.

A filter selector is exposed in the access page that is operable to select a filter to apply to the arrangement of quick links from among multiple available filter options (block 504). An access page may provide a filter selector in any suitable way, one example of which is the filter selector 410 shown and described in relation to FIG. 4. For instance, the example filter selector 410 of FIG. 4 is provided directly on the quick links access page 402. In this approach, the filter selector 410 is visible and available for use during the course of a user's interaction with the page. A filter selector may also be configured as a pop-up or slide out element. In this case, a user may selectively expose the filter selector by selecting a corresponding link, tool icon, or menu item. When not in use, the pop-up or slide out element may be hidden or closed out. Other configurations of a filter selector are also contemplated. In an implementation, the multiple available filter options are configured as selectable elements that are selectable to cause filtering of the quick links according to corresponding filters. Example filters include but are not limited to time and date filters, entity filters, location filter, and activity filters.

A selection of a filter to apply is received via the filter selector (block 506) and responsive to receiving the selection, the arrangement of quick links is rearranged into a filtered view in which quick links are placed into groups corresponding to the selected filter (block 508). For instance, a filtering module 118 may operate as discussed herein to produce a filtered view of quick links in which items are groups according to combinations of contextual metadata tags. As mentioned in the preceding discussion, the filtered view may be an image-based view having tag labels for each group to identify the groups and elements that represent content items within the groups. Additionally, some elements used to represent content items may include a thumbnail image that provides a preview of a least one of the content items. Individual elements within the groups are selectable to facilitate navigation of the web platform to access and render corresponding content items. Thus, the filtering enables interaction with different views of quick links by defining and/or applying different filters.

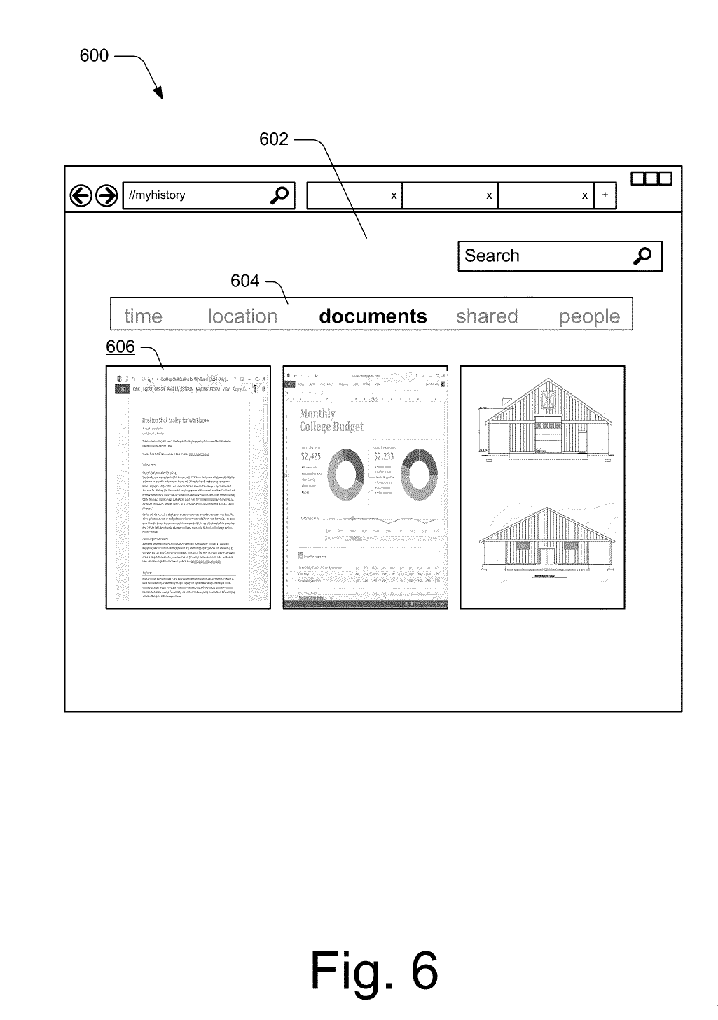

FIG. 6 depicts generally at 600 an example user interface having a visual representation of quick links with a filter selector in accordance with one or more implementations. Here, another example quick links access page 602 is shown that may be formed in accordance with techniques described herein. In the example, a filter selector 604 in the form of a tool bar is shown. The filter selector 604 enables selection of different filters to select a view of quick links data to show in the quick links access page 602. The different available filters represented for the filter selector 604 include filters for time, location, documents or content type, shared items or sharing status, and people. As illustrated, the documents filter is selected and accordingly image-based representations 606 of different documents are presented as content items in the page. The image-based representations 606 may be configured as icons, thumbnails, document previews (as shown), or other visual elements to identify recently used items from history or favorite items. The image-based representations may be selectable to access the corresponding documents within the web platform or via a different underlying application. Selection of a different one of the filter options causes a rearrangement to expose corresponding items and/or groups.

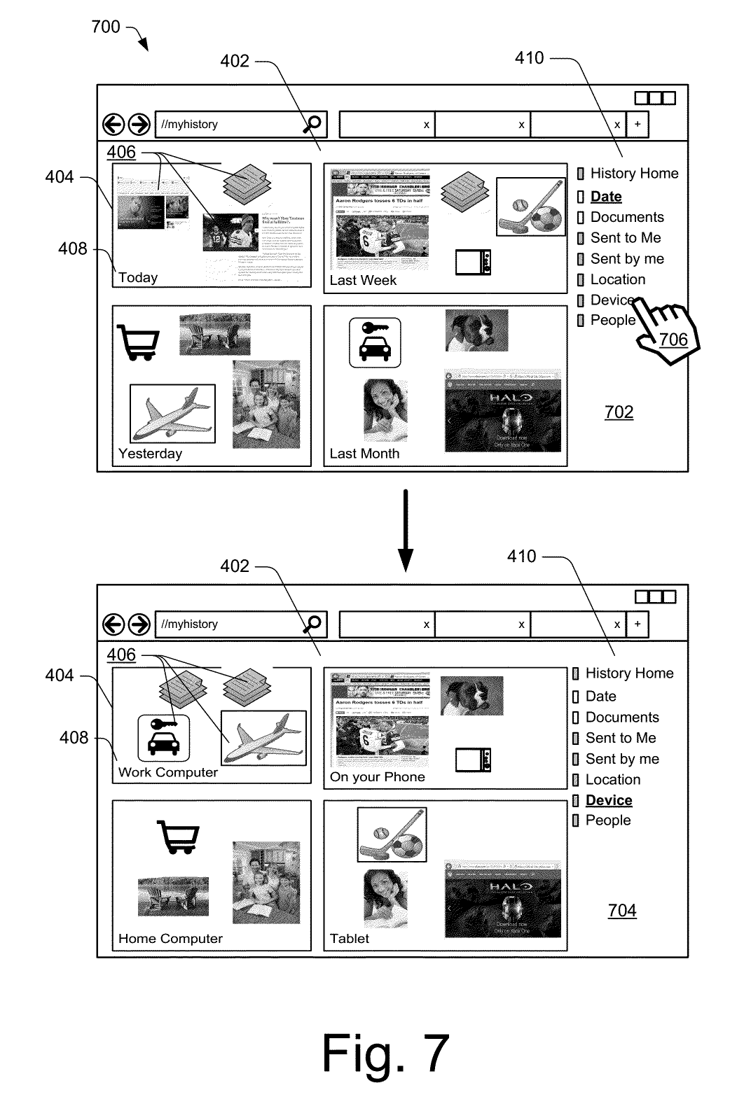

FIG. 7 depicts generally at 700 a representation of rearrangement of quick links based on a filter selection in accordance with one or more implementations. The rearrangement may occur in accordance with the example procedure 600 just discussed and is depicted with respect to different views of a quick links access page that may be formed in the manner described herein, such as the example quick links access page 402 discussed in relation to FIG. 4.

For instance, FIG. 7 illustrates a change from a view 702 to a view 704 that occurs responsive to interaction 706. View 702 depicts an arrangement of quick links data 114 into groups. The groups correspond to and are formed based upon application of a selected filter that filters the quick links data 114 based on contextual metadata tags and values (e.g., tags 210). The filter may be selected via selection functionality exposed via the filter view 702, examples of which include the filter selector 410 and filter selector 604 previously discussed. Arrangement of the groups 404 is controlled by the web platform to organize quick links data 114 using visual group elements 404 for multiple different groups, each of which contains corresponding quick link elements 406 for content items. The different groups may also each be configured to include tag labels 408

In the example view 702, a filter selector 410 is shown that includes different available filter options for the quick links access page 402, such as filters for history home, date, documents, location, device, etc. Filter options made available via the filter selector 410 are selectable to cause corresponding rearrangements of quick links data 114 and generation of different views having different groupings. For instance, view 702 illustrates a date filter being active via the filter selector 410 and accordingly the groups represented via visual group elements 404 are grouped by date. In particular, example groups in view 702 include groups for today, yesterday, last week, and last month.

User interaction to select or modify the active filter, via a filter selector or otherwise, initiates rearrangement of the quick links access page 402 to present a corresponding view. For example, FIG. 7 represents interaction 706 with the filter selector 410 to make a selection of one of the filter options, which in this example involves selection of a filter by device option. The interaction 706 causes a transition from the view 702 having date based groupings to the view 704 having device based groupings of quick links. In particular, view 704 includes a rearrangement of visual group elements 404 and quick links elements 406 into device based groups including groups corresponding to a work computer, home computer, phone, and tablet. In this case, elements for content items are placed into groups based upon the particular devices used to access or interact with the content items. Similar rearrangements and transitions between groups occur in response to selections of other filters via the filter selector 410 or otherwise. In this way, a user may employ filters to access different views of the quick links data, find items of interest, and navigate quickly back to content items.

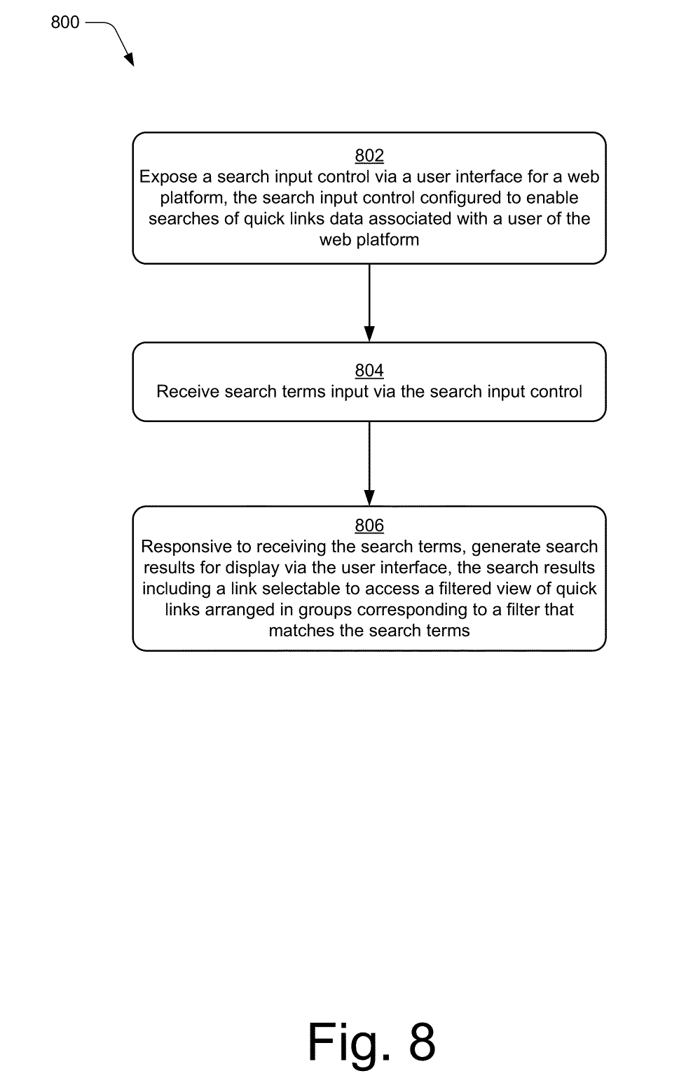

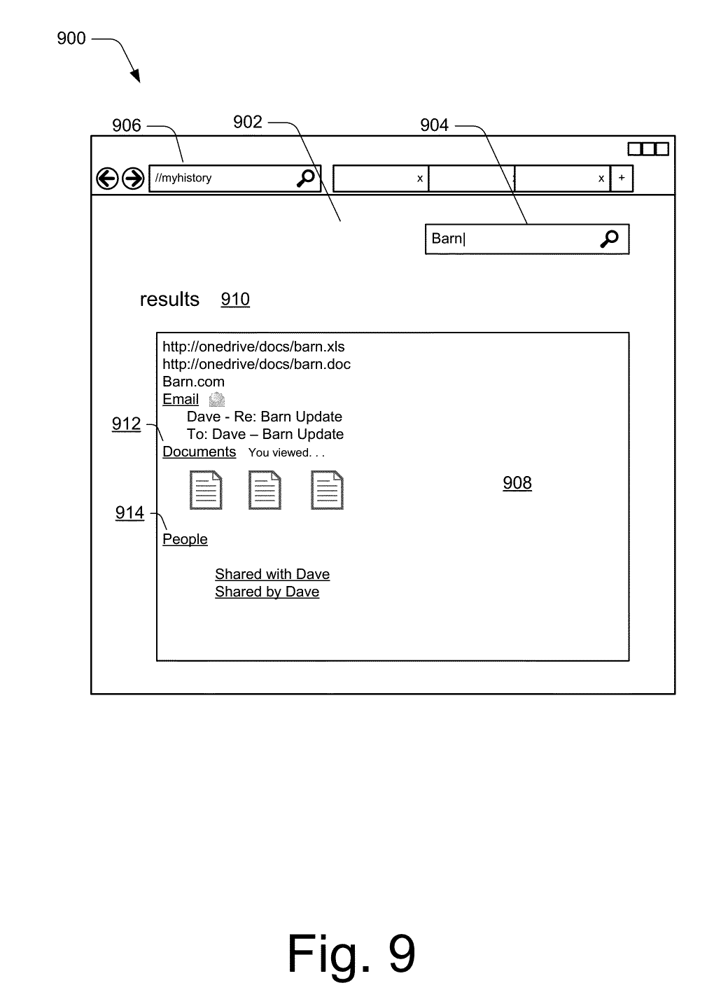

As noted previously, web platform 112 enables interaction with a search service 124 to perform search queries. Further, the search service 124 may expose contextual metadata for use by the web platform 112. In addition to setting up filters and creating different views, the web platform 112 may leverage contextual metadata and/or filters derived from the metadata to enhance search results provided in response to search queries. Rather than merely providing individual items as search results, the web platform 112 may also group some results into tag categories and/or provide links to different filtered views of items as part of the search results. Results returned may include a combination that includes one or more of individual items, tag groups items, and links to filtered views. For example, based on metadata tags associated with content items as discussed herein, search results may be automatically grouped into categories such as for dates, locations, people, devices, and document types. A presentation of search results may include image-based representations of the groups or alternatively text-based lists that reflect the groups. Further, search results may be configured to include links for access to different filtered views that match the search criteria. Example and details regarding techniques to include filter links as part of search results are discussed in relation to the example procedure of FIG. 8 and the example user interface of FIG. 9.

In particular, FIG. 8 depicts an example procedure 800 in which a link to a filtered view of quick links is returned as part of search results. A search input control is exposed via a user interface for a web platform, the search input control configured to enable searches of quick links data associated with a user of the web platform (block 802). For example, various user interfaces 120 and views described herein may be configured to provide search functionality through which a user may perform searches of content, including searches of quick links data. In one approach, an address bar of the web platform is designed as a search input control to enable searches in addition to display of URLs for accessed items. In addition or alternatively, a user interface may include a search input control as a separate element. In any case, a suitable search input control is provided that accepts input of search terms and cause a search for corresponding items to be conducted. Results generated in response to input search terms may be rendered within a user interface to facilitate selection among different content items and navigation to access the items.

Search terms input via the search input control are received (block 804) and responsive to receiving the search terms, search results are generated for display via the user interface, the search results including a link selectable to access a filtered view of quick links arranged in groups corresponding to a filter that matches the search terms (block 806). For example, one or more filters as discussed herein may be matched to search terms input via a search input control. Each filter may be configured to arrange quick links into groups corresponding to different categories of contextual metadata tags specified by the filter. By way of example and not limitation, a filter when applied may cause arrangement of the quick links into groups corresponding to one or more of time, location, content type, sharing status, or people.

The matching of filters with search terms occurs by comparing tags 210 associated with filters to the search criteria. In other words, generating the search results may involve matching the search terms to one or more contextual metadata tags specified by the filter and then creating a corresponding link to access the filtered view based on the matching. When sufficient matches to filters are found, links are generated for matching filters and may be included in the search results. Thus, users are able to access corresponding filtered views directly through the search results.

Additionally, individual tags that match the search criteria may be identified by comparing tags 210 to the search criteria. Identified tags may be used to arrange search results, such as into multiple tagged based groups. Consequently, a user is able to utilize tags 210 as search terms and search results may be organized into tag based groups accordingly. Since tags may be easier to remember than full URLs or document names, the use of tags and filters as part of searches enhances the search process making it quicker and also more likely for a user to find particular content the user is attempting to find.

FIG. 9 depicts generally at 900 an example user interface for accessing and searching quick links in accordance with one or more implementations. In this example, a quick links search page 902 includes a search input control 904. The search input control 904 is depicted as a being an individual, standalone element of the page. As noted search functionality may also be integrated with an address bar 906 as represented by the search icon included with the address bar 906. In the depicted example, though, a search is being conducted via the search input control 904 with the term “barn” being input into the control. The term barn may correspond to a barn building project that the user is undertaking. The term barn may even be a custom field that the user created to keep track of related content the user accesses via the web platform. Input of the search terms, causes generation and output of search results 908 via a results portion 910 of the quick links search page 902.

Notably, the search results 908 include links generated for filters matched to the term barn. For example, search results 908 include a link 912 to a document filter view and a link 912 to a people filter view. FIG. 9 also illustrates arrangement of search results into tagged based groups. For example, results are presented in a list for that includes categories for email, documents, and people. Within the people group, sub-groups for Shared by Dave and Shared with Dave are also represented. Naturally, image-based views comparable to the examples of FIGS. 4, 6 and 7 may also be employed to present search results that make use of tags 210, tagged based groupings, and/or links to filtered views. Thus, search results may be configured in various way to include information derived from web content tagging and filtering techniques described herein.

Having considered some example details, consider now a discussion of an example system and devices that may be employed to implement aspects of the techniques described herein in one or more implementations.

Example System and Device

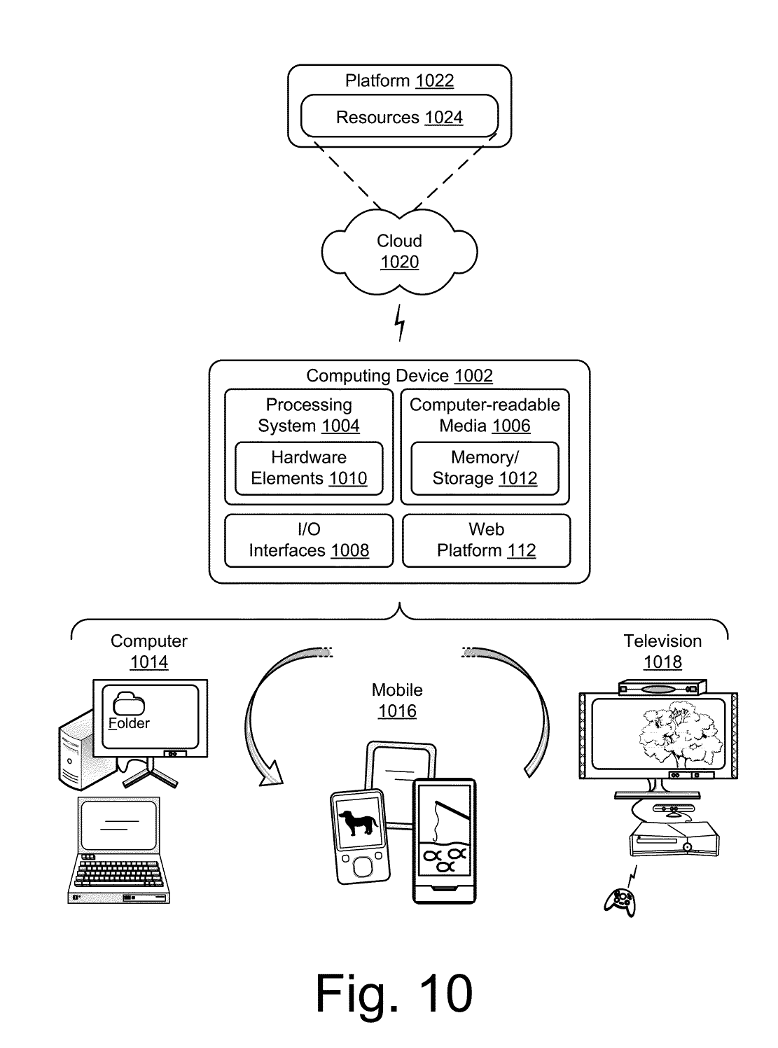

FIG. 10 illustrates an example system generally at 1000 that includes an example computing device 1002 that is representative of one or more computing systems and/or devices that may implement the various techniques described herein. The computing device 1002 may be, for example, a server of a service provider, a device associated with the client (e.g., a client device), an on-chip system, and/or any other suitable computing device or computing system.

The example computing device 1002 as illustrated includes a processing system 1004, one or more computer-readable media 1006, and one or more I/O interfaces 1008 that are communicatively coupled, one to another. Although not shown, the computing device 1002 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1004 is representative of functionality to perform one or more operations using hardware. Accordingly, the processing system 1004 is illustrated as including hardware elements 1010 that may be configured as processors, functional blocks, and so forth. This may include implementation in hardware as an application specific integrated circuit or other logic device formed using one or more semiconductors. The hardware elements 1010 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 1006 is illustrated as including memory/storage 1012. The memory/storage 1012 represents memory/storage capacity associated with one or more computer-readable media. The memory/storage 1012 may include volatile media (such as random access memory (RAM)) and/or nonvolatile media (such as read only memory (ROM), Flash memory, optical disks, magnetic disks, and so forth). The memory/storage 1012 may include fixed media (e.g., RAM, ROM, a fixed hard drive, and so on) as well as removable media (e.g., Flash memory, a removable hard drive, an optical disc, and so forth). The computer-readable media 1006 may be configured in a variety of other ways as further described below.

Input/output interface(s) 1008 are representative of functionality to allow a user to enter commands and information to computing device 1002, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 1002 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 1002. By way of example, and not limitation, computer-readable media may include “computer-readable storage media” and “communication media.”

“Computer-readable storage media” refers to media and/or devices that enable storage of information in contrast to mere signal transmission, carrier waves, or signals per se. Thus, computer-readable storage media does not include signal bearing media or signals per se. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Communication media” may refer to a signal-bearing medium that is configured to transmit instructions to the hardware of the computing device 1002, such as via a network. Communication media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1010 and computer-readable media 1006 are representative of instructions, modules, programmable device logic and/or fixed device logic implemented in a hardware form that may be employed in some embodiments to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules including applications 110, tagging module 116, filtering module 118, web platform 112 and other program modules may be implemented as one or more instructions and/or logic embodied on some form of computer-readable storage media and/or by one or more hardware elements 1010. The computing device 1002 may be configured to implement particular instructions and/or functions corresponding to the software and/or hardware modules. Accordingly, implementation of modules as a module that is executable by the computing device 1002 as software may be achieved at least partially in hardware, e.g., through use of computer-readable storage media and/or hardware elements 1010 of the processing system. The instructions and/or functions may be executable/operable by one or more articles of manufacture (for example, one or more computing devices 1002 and/or processing systems 1004) to implement techniques, modules, and examples described herein.

As further illustrated in FIG. 10, the example system 1000 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 1000, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 1002 may assume a variety of different configurations, such as for computer 1014, mobile 1016, and television 1018 uses. Each of these configurations includes devices that may have generally different constructs and capabilities, and thus the computing device 1002 may be configured according to one or more of the different device classes. For instance, the computing device 1002 may be implemented as the computer 1014 class of a device that includes a personal computer, desktop computer, a multi-screen computer, laptop computer, netbook, and so on.

The computing device 1002 may also be implemented as the mobile 1016 class of device that includes mobile devices, such as a mobile phone, portable music player, portable gaming device, a tablet computer, a multi-screen computer, and so on. The computing device 1002 may also be implemented as the television 1018 class of device that includes devices having or connected to generally larger screens in casual viewing environments. These devices include televisions, set-top boxes, gaming consoles, and so on.

The techniques described herein may be supported by these various configurations of the computing device 1002 and are not limited to the specific examples of the techniques described herein. This is illustrated through inclusion of the web platform 112 on the computing device 1002. The functionality of the web platform 112 and other modules may also be implemented all or in part through use of a distributed system, such as over a “cloud” 1020 via a platform 1022 as described below.

The cloud 1020 includes and/or is representative of a platform 1022 for resources 1024. The platform 1022 abstracts underlying functionality of hardware (e.g., servers) and software resources of the cloud 1020. The resources 1024 may include applications and/or data that can be utilized while computer processing is executed on servers that are remote from the computing device 1002. Resources 1024 can also include services provided over the Internet and/or through a subscriber network, such as a cellular or Wi-Fi network.

The platform 1022 may abstract resources and functions to connect the computing device 1002 with other computing devices. The platform 1022 may also serve to abstract scaling of resources to provide a corresponding level of scale to encountered demand for the resources 1024 that are implemented via the platform 1022. Accordingly, in an interconnected device embodiment, implementation of functionality described herein may be distributed throughout the system 1000. For example, the functionality may be implemented in part on the computing device 1002 as well as via the platform 1022 that abstracts the functionality of the cloud 1020.

### EXAMPLE IMPLEMENTATIONS

Example implementations of tagging and filtering web content described herein include, but are not limited to, one or any combinations of one or more of the following examples:

### Example 1

A method implemented by one or more computers of a web platform comprising: automatically tagging content items added to quick links data during a user's browsing activity with contextual metadata tags indicative of filterable properties of browsing activity; receiving a request to access the quick links data via a user interface provided by the web platform; responsive to the request, filtering the quick links data to generate an arrangement of quick links in groups of related items each corresponding to one or more of the contextual metadata tags; and configuring the user interface with visual representations for each of the groups to expose the arrangement of quick links and facilitate user interaction to access content items through the web platform using the groups.

### Example 2

The method of any one or more of the examples in this section, wherein the quick links data comprises a history of content items encountered during the user's browsing activity that is recorded by the web platform.

### Example 3

The method of any one or more of the examples in this section, wherein the quick links data comprises favorite list data indicative of content items selected for inclusion in a favorite list for quick access.

### Example 4

The method of any one or more of the examples in this section, wherein filtering comprises applying one or more pre-selected filters defined for the web platform.

### Example 5

The method of any one or more of the examples in this section, wherein the contextual metadata tags include at least one custom tag defined by a user.

### Example 6

The method of any one or more of the examples in this section, further comprising configuring the user interface to expose a filter selector operable to select filters to apply to the quick links data and cause rearrangement of the arrangement of quick links in accordance with selected filters.

### Example 7

method of any one or more of the examples in this section, wherein the contextual metadata tags include tags for one or more of time and date, locations, device IDs, content categories, task categories, source IDs, page referrals, content sharing and rating data, or application IDs.

### Example 8

The method of any one or more of the examples in this section, wherein the arrangement of quick links in groups is configured to provide an image-based view of the user's browsing activity that includes preview images for one or more of the content items.

### Example 9

The method of any one or more of the examples in this section, further comprising sending commands and data for the user interface having the arrangement of quick links to control operation of a graphics processing system to output the user interface for display via a display device.

### Example 10

The method of any one or more of the examples in this section, further comprising communicating quick links data with corresponding contextual metadata tags to a service provider to cause storage in association with a user account and enable access to the quick links data and corresponding contextual metadata tags from multiple devices used to access the user account.

### Example 11

A computing device, comprising: a display device; and at least a memory and a processor to implement a web platform, the web platform configured to: output a view of a quick links access page having an arrangement of quick links in groups associated with common contextual metadata tags for display via the display device; expose in the access page a filter selector operable to select a filter to apply to the arrangement of quick links from among multiple available filter options; receive a selection of a filter to apply via the filter selector; and responsive to receiving the selection, rearranging the arrangement of quick links into a filtered view in which quick links are placed into groups corresponding to the selected filter.

### Example 12

The computing device of any one or more of the examples in this section, wherein the multiple available filter options are configured as selectable elements that are selectable to cause filtering of the quick links according to time and date filters, entity filters, location filter, and activity filters.

### Example 13

The computing device of any one or more of the examples in this section, wherein the quick links correspond to one or more of items added to a user's browsing history, bookmarks, or favorites.

### Example 14

The computing device of any one or more of the examples in this section, wherein the filtered view is an image-based view having tag labels for each group to identify the groups and elements that represent content items within the groups.

### Example 15

The computing device of any one or more of the examples in this section, wherein the elements used to represent content items include a thumbnail image that provides a preview of a least one of the content items.

### Example 16

The computing device of any one or more of the examples in this section, wherein individual elements within the groups are selectable to facilitate navigation of the web platform to access and render corresponding content items.

### Example 17

A system comprising: a processing system having one or more processors; one or more computer readable media storing instructions that when executed via the processing system implement a web platform configured to perform operations comprising: exposing a search input control via a user interface for the web platform, the search input control configured to enable searches of quick links data associated with a user of the web platform; receiving search terms input via the search input control; and responsive to receiving the search, generating search results for display via the user interface, the search results including a link selectable to access a filtered view of quick links arranged in groups corresponding to a filter that matches the search terms.

### Example 18

The system of any one or more of the examples in this section, wherein generating search results comprises matching the search terms to one or more contextual metadata tags specified by the filter and creating the link to access the filtered view based on the matching.

### Example 19

The system of any one or more of the examples in this section, wherein the filtered view filter is configured to arrange quick links into groups corresponding to different categories of contextual metadata tags specified by the filter

### Example 20

The system of any one or more of the examples in this section, wherein the filter cause arrangement of the quick links into groups corresponding to one or more of time, location, content type, sharing status, or people.

### CONCLUSION

Although embodiments of determining browsing activities have been described in language specific to features and/or methods, the appended claims are not necessarily limited to the specific features or methods described. Rather, the specific features and methods are disclosed as example implementations of determining browsing activities, and other equivalent features and methods are intended to be within the scope of the appended claims. Further, various different embodiments are described and it is to be appreciated that each described embodiment can be implemented independently or in connection with one or more other described embodiments.

What is claimed is:

1. A method implemented by one or more computers of a web platform comprising:
automatically tagging content items added to quick links data during a user's browsing activity with contextual metadata tags indicative of filterable properties of browsing activity;
receiving a request to access the quick links data via a user interface provided by the web platform;
responsive to the request, filtering the quick links data to generate an arrangement of quick links in groups of related items each corresponding to one or more of the contextual metadata tags; and
configuring the user interface with visual representations for each of the groups to expose the arrangement of quick links and facilitate user interaction to access content items through the web platform using the groups.

2. The method of claim 1, wherein the quick links data comprises a history of content items encountered during the user's browsing activity that is recorded by the web platform.

3. The method of claim 1, wherein the quick links data comprises favorite list data indicative of content items selected for inclusion in a favorite list for quick access.

4. The method of claim 1, wherein filtering comprises applying one or more pre-selected filters defined for the web platform.

5. The computer-implemented method of claim 1, wherein the contextual metadata tags include at least one custom tag defined by a user.

6. The computer-implemented method of claim 1, further comprising configuring the user interface to expose a filter selector operable to select filters to apply to the quick links data and cause rearrangement of the arrangement of quick links in accordance with selected filters.

7. The computer-implemented method of claim 1, wherein the contextual metadata tags include tags for one or more of time and date, locations, device IDs, content categories, task categories, source IDs, page referrals, content sharing and rating data, or application IDs.

8. The computer-implemented method of claim 1, wherein the arrangement of quick links in groups is configured to provide an image-based view of the user's browsing activity that includes preview images for one or more of the content items.

9. The computer-implemented method of claim 1, further comprising sending commands and data for the user interface having the arrangement of quick links to control operation of a graphics processing system to output the user interface for display via a display device.

10. The computer-implemented method of claim 1, further comprising communicating quick links data with corresponding contextual metadata tags to a service provider to cause storage in association with a user account and enable access to the quick links data and corresponding contextual metadata tags from multiple devices used to access the user account.

11. A computing device, comprising:
a display device; and
at least a memory and a processor to implement a web platform, the web platform configured to:
output a view of a quick links access page having an arrangement of quick links in groups associated with common contextual metadata tags for display via the display device;
expose in the access page a filter selector operable to select a filter to apply to the arrangement of quick links from among multiple available filter options;
receive a selection of a filter to apply via the filter selector; and
responsive to receiving the selection, rearranging the arrangement of quick links into a filtered view in which quick links are placed into groups corresponding to the selected filter.

12. The computing device of claim 11, wherein the multiple available filter options are configured as selectable elements that are selectable to cause filtering of the quick links according to time and date filters, entity filters, location filter, and activity filters.

13. The computing device of claim 11, wherein the quick links correspond to one or more of items added to a user's browsing history, bookmarks, or favorites.

14. The computing device of claim 11, wherein the filtered view is an image-based view having tag labels for each group to identify the groups and elements that represent content items within the groups.

15. The computing device of claim 14, wherein the elements used to represent content items include a thumbnail image that provides a preview of a least one of the content items.

16. The computing device of claim 14, wherein individual elements within the groups are selectable to facilitate navigation of the web platform to access and render corresponding content items.

17. A system comprising:
a processing system having one or more processors;
one or more computer readable media storing instructions that when executed via the processing system implement a web platform configured to perform operations comprising:
exposing a search input control via a user interface for the web platform, the search input control configured to enable searches of quick links data associated with a user of the web platform;
receiving search terms input via the search input control; and
responsive to receiving the search, generating search results for display via the user interface, the search results including a link selectable to access a filtered view of quick links arranged in groups corresponding to a filter that matches the search terms.

18. The system of claim 17, wherein generating search results comprises matching the search terms to one or more contextual metadata tags specified by the filter and creating the link to access the filtered view based on the matching.

19. The system of claim 17, wherein the filtered view filter is configured to arrange quick links into groups corresponding to different categories of contextual metadata tags specified by the filter.

20. The system of claim 17, wherein the filter cause arrangement of the quick links into groups corresponding to one or more of time, location, content type, sharing status, or people.
